(19) United States
(12) Patent Application Publication
(10) Pub. No.: US 2003/0197653 A1
(43) Pub. Date: Oct. 23, 2003

(54) RFID antenna apparatus and system

(76) Inventors: Russell Barber, Scotts Valley, CA (US); Mark Nicholson, Scotts Valley, CA (US)

Correspondence Address: Ralph C. Francis, Francis Law Group, 1808 Santa Clara Ave., Alameda, CA, 94501, US

(21) Appl. No.: 10/418,705

(22) Filed: Apr. 18, 2003

Related U.S. Application Data
(60) Provisional application No. 60/375,093, filed on Apr. 22, 2002.

(51) Int. Cl. H01Q 11/12; H01Q 21/00

(52) U.S. Cl. 343/742; 343/867

(57) ABSTRACT

A RFID antenna apparatus and system comprising substantially coplanar first and second loop elements and a crossover element that generally define an H-shape, the first and second loop elements having substantially similar geometric shapes of substantially equal dimension, and a drive element.

### FIELD OF THE PRESENT INVENTION

The present invention relates generally to radio frequency identification (RFID) systems. More particularly, the invention relates to an improved RFID antenna apparatus and system.

### BACKGROUND OF THE INVENTION

RFID systems are well known in the art. Such systems include active systems having battery powered transmission/receiving circuitry, such as the RFID system disclosed in U.S. Pat. No. 4,274,083, and passive systems in which the transponder (or tag) receives its power from the base station or antenna system, such as the RFID system disclosed in U.S. Pat. No. 4,654,658.

A typical RFID system is made up of reusable tags fixed to or embedded in product carriers, an antenna system that interrogates the tags via an RF link and a controller. The host (or computer) system interfaces with the controller and directs the interrogation of the tags.

The RFID system thus provides effective means of identifying, monitoring, and controlling materials in a closed loop process. In a factory environment, the tags are employed as the transport mechanism between “islands of automation,” providing a record of each process that can be acted upon immediately or downloaded later for analysis.

In certain types of RFID systems it is known to provide one or more loop antennas having various configurations wherein coupling between the antenna and its proximate surrounding (i.e., near-field) is high, but wherein coupling between the antenna and its distant surrounding (i.e., far-field) is minimized. Such systems are generally employed for “near-field” communications or sensing applications.

For example, a typical RFID system usually includes both a transmit antenna and a receive antenna, which collectively establish a detection zone. The transmit antenna generates an electromagnetic field, which can be fixed or variable, within a small range of a first predetermined frequency. The tags each include a resonant circuit having a predetermined resonant frequency generally equal to the first frequency. When one of the tags is present in the detection zone, the field generated by the transmit antenna induces a voltage in the resonant circuit in the tag, which causes the resonant circuit to resonate and thereby generate an electromagnetic field that produces a disturbance in the field within the detection zone. The receive antenna detects the electromagnetic field disturbance, which can be translated to item identification or other pertinent data.

Various antenna configurations have been employed to facilitate the noted communication to and from a tag. The configurations include multiple loop RFID antenna systems, such as the RFID antenna system disclosed in co-pending application Ser. No. 10/114,580, filed Apr. 1, 2002, and conventional two loop, figure eight (i.e., FIG. 8) RFID antenna systems, such as the systems disclosed in U.S. Pat. Nos. 5,602,556 and 5,914,692.

In U.S. Pat. No. 5,602,556, a two-loop, figure eight antenna system is disclosed, wherein the loops are separated from each other such that the shared sides are no longer shared or immediately adjacent to each other. This separation causes the diameter of the toroid-shaped zone of high coupling proximate to the antenna to be increased, thereby increasing the distance by which the transmit and receive antennas of a RFID system can be separated.

In U.S. Pat. No. 5,914,692, a further figure eight antenna system is disclosed. The system includes a pair of triangular loops of generally equal dimensions and shape wherein the loops are coplanar and positioned on opposite sides of a central axis in the plane of the loops. The loops are connected to each other by a crossover segment having a length at least equal to a length of the shortest side of the loops such that when connected to a drive circuit, the current in the loops flows in opposite directions and thereby generates substantially canceling fields.

A major drawback of conventional figure eight antenna systems, including the systems disclosed in the '556 and '692 patents, is that a weak detection field or “hole” often occurs at the center of the detection zone, which is the zone generally parallel to the crossover of the loops of the figure eight. The “hole” (or null point) is especially prominent when the tag is oriented in a position that is normal or perpendicular to the axis of the crossover area.

Various techniques have been employed to address the issue of weak field production in the center zone. One technique is to employ a three loop antenna. However, a three loop antenna which is large enough to cover a volume of several cubic meters will have a self-resonance below 13.56 MHz, which is a desired frequency for certain tag applications. Accordingly, such an antenna cannot be tuned to 13.56 MHz.

A further technique that is employed to develop an effective field in the center zone comprises driving a center loop with the same current source as the primary loop. However, this technique is not optimum, since “hot” and “cold” areas develop from positive reinforcement and destructive cancellation, respectively, due to field components of the figure eight and center loop with opposite polarity. By rotating the field, the antenna basically averages the hot and cold spots, and provides uniform field production.

Another conventional technique for generating a rotating field is to drive the center loop 90 degrees out of phase with respect to the other loops using a series/parallel matching network.

Both of these conventional schemes for providing a rotating, uniform field require that the center loop be electrically connected to the figure eight loop. One conventional connection scheme is to electrically connect the center loop to the figure eight loop through a phase shifting network. However, the phase shifting network adds cost and complexity to the antenna. Also, losses in the network components reduce the efficiency of the antenna.

In U.S. Pat. No. 6,166,706, a multiple loop antenna is disclosed having a figure eight or dumbbell shaped loop element and a center loop element that overlaps a portion of the figure eight loop. The center loop element does not, however, have a direct or physical electrical connection to the figure eight loop element. According to the invention, the antenna produces a rotating composite field when driven by a drive element.

Although the noted antenna system purportedly provides an effective field in the center zone, the antenna system has several drawbacks. A major drawback of the antenna system is the requirement of two separate loop elements.

It is therefore an object of the present invention to provide a RFID antenna apparatus and system having a substantially H-shaped antenna structure that provides a tag read area that is substantially devoid of holes or null points.

It is another object of the present invention to provide a RFID antenna apparatus and system that provides a maximum near H-field.

It is another object of the invention to provide a RFID antenna apparatus and system that provides a minimum far E-field.

It is yet another object of the invention to provide a RFID antenna apparatus and system that provides a maximum tag read area.

### SUMMARY OF THE INVENTION

In accordance with the above objects and those that will be mentioned and will become apparent below, the RFID antenna apparatus and system in accordance with this invention comprises a substantially H-shaped antenna structure, the antenna structure having substantially coplanar first and second loop elements and a crossover element, the first and second loop elements having substantially similar geometric shapes of substantially equal dimension, the crossover element having a pair of spaced, substantially parallel conductors electrically connecting said first and second loop elements; and a drive element for driving the antenna structure.

The advantages of the RFID antenna system include (i) an optimal tag read area that is substantially devoid of holes or null points; (ii) enhanced vertical coverage without the need for multiple loop elements or rotating fields; (iii) enhanced “near field” read range; (iv) minimal coupling in the “far field”; and (v) minimal field projection into the ground.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a perspective view of a simple RFID system;

FIG. 2 is a top plan view of a prior art RFID tag;

FIG. 3 a schematic illustration of a multiple loop RFID antenna system;

FIG. 4 is a front plan view of one embodiment of the RFID antenna apparatus, according to the invention;

FIGS. 5 through 9 are front plan views of additional embodiments of the RFID antenna apparatus, illustrating various antenna structure geometric configurations and orientations, according to the invention;

FIG. 10 is a side plan view of the RFID antenna apparatus shown in FIGURE;

FIGS. 11 and 12 are schematic illustrations of modular RFID antenna systems, incorporating the RFID antenna apparatus of the invention;

FIG. 13 is a schematic illustration of a conventional FIG. 8 antenna system;

FIGS. 14-17 are electric far field surface plots for the FIG. 8 antenna system shown in FIG. 13;

FIG. 18 is a schematic illustration of an embodiment of the RFID antenna apparatus, according to the invention;

FIGS. 19-22 are electric far field surface plots for the RFID antenna apparatus shown in FIG. 18;

FIG. 23 is a schematic illustration of an additional embodiment of the RFID antenna apparatus, according to the invention; and

FIGS. 24-27 are electric far field surface plots for the RFID antenna apparatus shown in FIG. 23.

### DETAILED DESCRIPTION OF THE PREFERRED EMBODIMENT

Before describing the present invention in detail, it is to be understood that this invention is not limited to particularly exemplified structures or system parameters as such may, of course, vary. It is also to be understood that the terminology used herein is for the purpose of describing particular embodiments of the invention only, and is not intended to be limiting.

All publications, patents and patent applications cited herein, whether supra or infra, are hereby incorporated by reference in their entirety.

It must be noted that, as used in this specification and the appended claims, the singular forms “a, “an” and “the” include plural referents unless the content clearly dictates otherwise. Thus, for example, reference to “an electromagnetic field” includes two or more such fields, reference to “an antenna loop” includes two or more such loops and the like.

Definitions

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In describing the present invention, the following terms will be employed, and are intended to be defined as indicated below.

By the term “near-field”, as used herein, it is meant to mean an area less than approximately 0.1 wavelength from an antenna.

By the term “far-field”, as used herein, it is meant to mean an area thirty (30) meters or slightly less than one wavelength from an antenna operating at 8.2 MHz.

By the term “RFID tag”, as used herein, it is meant to mean and include radio frequency identification tags, smart tags, smart labels and inlets.

By the term “tag read area”, it is meant to mean the area defined by the electromagnetic field of the antenna system wherein effective communication to and from a tag disposed therein is achieved.

As will be appreciated by one having ordinary skill in the art, the RFID antenna apparatus and system of the invention substantially reduces or eliminates the disadvantages and drawbacks associated with prior art RFID antenna systems. In one preferred embodiment of the invention, the antenna system, described in detail below, generally includes at least one substantially continuous resonant loop antenna structure having two offset loop portions that generally define an H-shape.

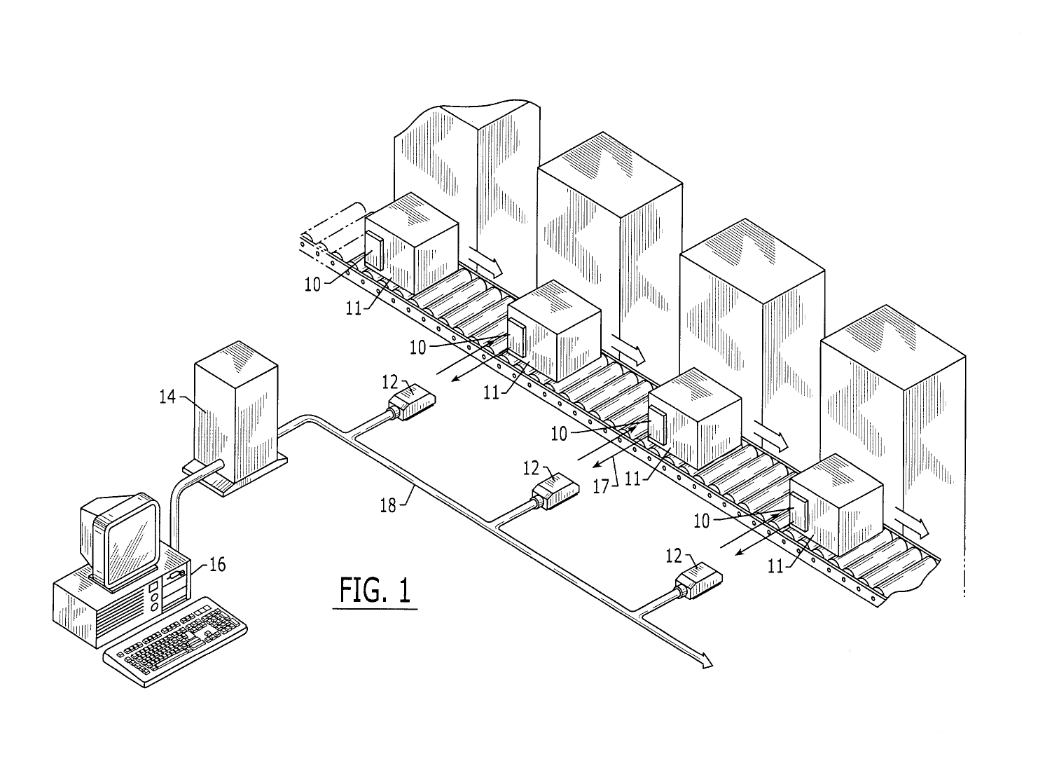

Referring first to FIG. 1, there is shown a simple read/write RFID system. The system typically comprises one or more tags (or transponders) 10, containing some data in memory, an antenna system 12 for communicating with the tags 10, and a controller 14 for managing the communication interface. The host system 16 interfaces with the controller 14 and directs the interrogation of the tags 10 disposed on or embedded in the product carriers 11 and any following action via parallel, serial or bus communications 18.

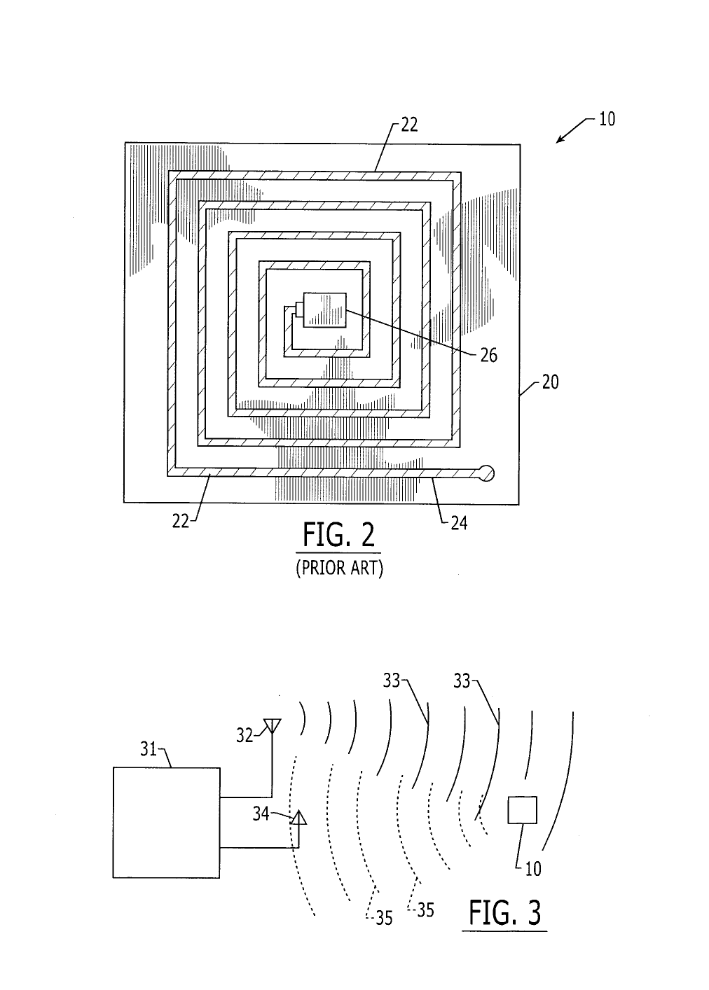

Referring now to FIG. 2, there is shown a prior art RFID tag 10. The tag 10 includes a substrate 20 having one or more circuits 22 and capacitors (referred to herein generally as resonant loop 24) thereon and a RFID chip (or die) 26. The substrate 20 typically comprises a rigid or flexible PC board with the RFID chip 26 affixed thereto.

Referring now to FIG. 3, there is shown a schematic illustration of a prior art RFID antenna system 30. As illustrated in FIG. 3, the antenna system 30 includes a transceiver 31 that is in communication with a transmit antenna 32 and receive antenna 34.

As discussed above, when the tag 10 is disposed in the detection or interrogation zone, the magnetic component of the RF electromagnetic field (designated 33) transmitted by the transmit antenna 32 causes RF current to flow through the tag resonant loop 24. The chip 26 then causes the resonant loop 24 to radiate a magnetic field component 35 that is intercepted by the receive antenna 34.

As will be appreciated by one having ordinary skill in the art, the transmit and receive frequencies employed in RFID Antenna Systems can be substantially similar or different. The noted frequencies can also be within the portion of the electromagnetic spectrum that is suitable for radio communications (e.g., 0.1 MHz to 50 GHz).

Typically, the transmit and receive frequencies are in the range of approximately 13-14 MHz. More preferably, the transmit frequency is approximately 13.56 MHz, which is an authorized FCC frequency.

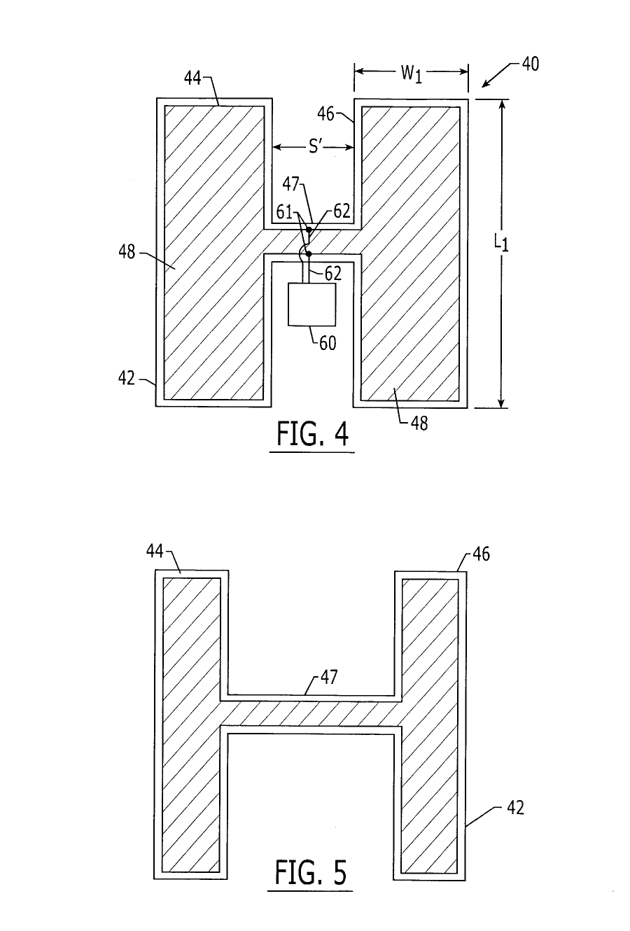

Referring now to FIG. 4, there is shown one embodiment of the RFID antenna 40 of the invention. The antenna 40 includes a substantially continuous resonant antenna structure 42 having two loop elements 44, 46 and a crossover element 47 that generally define a H-shape. As illustrated in FIG. 10, the loop elements 44, 46 have substantially similar geometric shapes and are substantially coplanar.

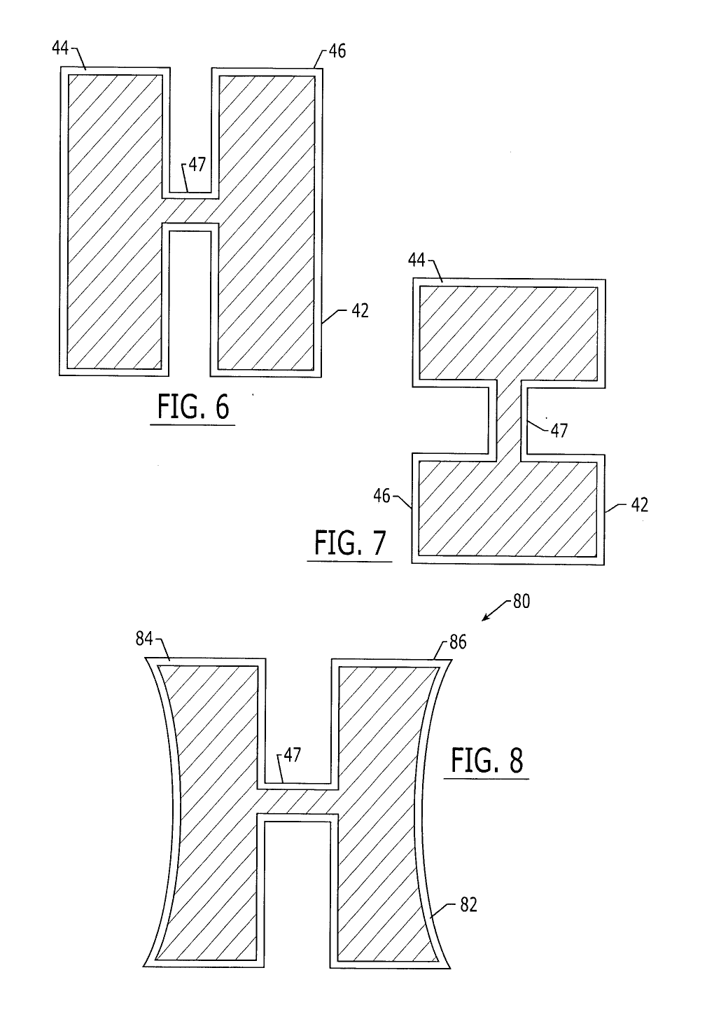

Preferably, the loop elements 44, 46 are substantially rectangular in shape, as illustrated in FIGS. 4-8. However, other loop element shapes, such as substantially circular, elliptical or the bow-tie shape illustrated in FIG. 8 and described in detail below, can be employed within the scope of the invention.

The antenna structure 42 is preferably constructed of a high-conductivity material, such as aluminum, tin and copper. In a preferred embodiment, the antenna structure 42 is constructed of copper tubing (i.e., substantially circular cross-sectional area) having a diameter in the range of 0.01-2 in., more preferably, 0.25-1.0 in. As will be appreciated by one having ordinary skill in the art, the antenna structure 42 can also be constructed of other shaped tubing, one or more turns of a conductor or wire of any suitable type, a single wire, or an electrically conductive decorative element.

According to the invention, each loop element 44, 46 preferably has a nominal width, W₁, in the range of approximately 4-15 in. more preferably, approximately 8-12 in., and a nominal length, L₁, preferably in the range of approximately 36-100 in., more preferably, approximately 48-90 in.

Even more preferably, each loop element 44, 46 defines a loop region 48 having an area greater than approximately 0.5 ft². More preferably, the loop region 48 has an area in the range of approximately 1-10.5 ft².

In a preferred embodiment, the spacing between each loop element 44, 46 (designated S′) is in the range of approximately 1-5 ft. More preferably, the spacing S′ is in the range of approximately 2-4 ft.

Referring back to FIG. 4, the circuitry (or drive element) for the RFID antenna 40 of the invention will now be described in detail. As illustrated in FIG. 4, in one embodiment of the invention, the antenna structure 42 is preferably connected to a 1:1 balun 60 (i.e., balanced to unbalanced RF transformer) via feed lines 62. To ensure proper balance and phase reversal, the feed points 61a, 61b are preferably disposed proximate the crossover element 47 of the antenna structure 42.

Preferably, the antenna 40 is operative at radio frequencies in the range of 1-50 MHz. However, it should be understood that the antenna 40 could be operated at lower frequencies without departing from the scope of the present invention.

In one preferred embodiment of the invention, a frequency in the range of 13-14 MHz is employed. More preferably, a frequency equal to approximately 13.56 MHz is employed.

According to the invention, the antenna 40 is operable with an input power less than approximately 30 watts, while maintaining the FCC requirement of 10,000 uv/m. More preferably, the input power is in the range of 10-20 watts.

Referring now to FIG. 8, there is shown a further embodiment of an antenna 80 of the invention. In this embodiment, the antenna structure 82 includes loop elements 84, 86 that define a “bow-tie” shape. Applicant has found that the bow-tie shape reduces the natural field gradient that is commonly associated with prior art loop antenna systems.

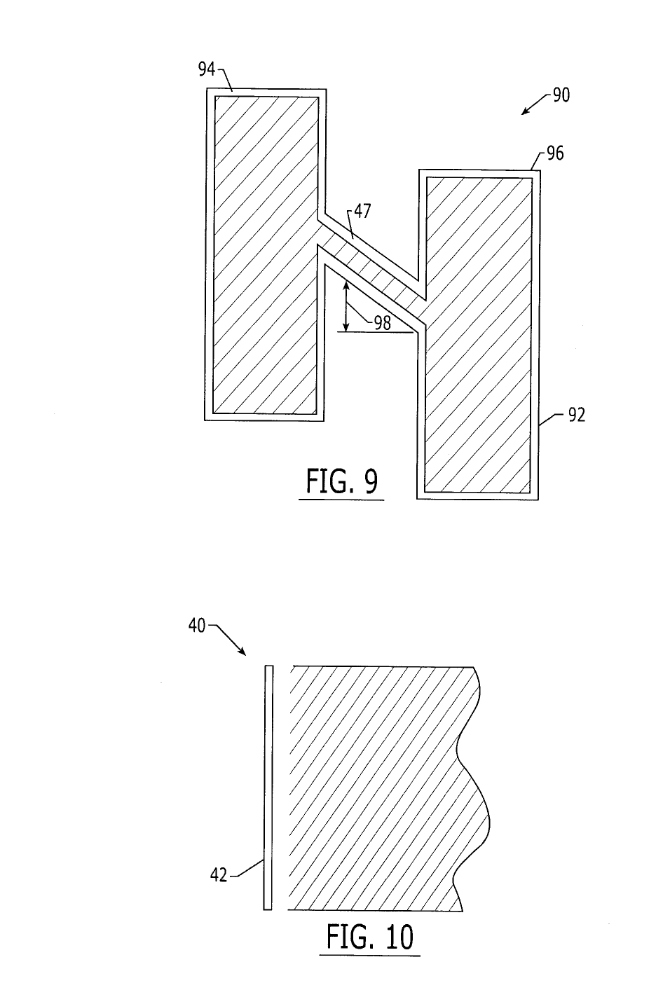

Referring now to FIG. 9, there is shown yet another embodiment of an antenna 90 of the invention. As illustrated in FIG. 9, the antenna structure 92 similarly includes two loop elements 94, 96. However, in this embodiment, the loop elements 94, 96 are vertically offset (designated generally 98). As will be appreciated by one having ordinary skill in the art, the vertical offset 98 enhances the vertical plane of the tag read area.

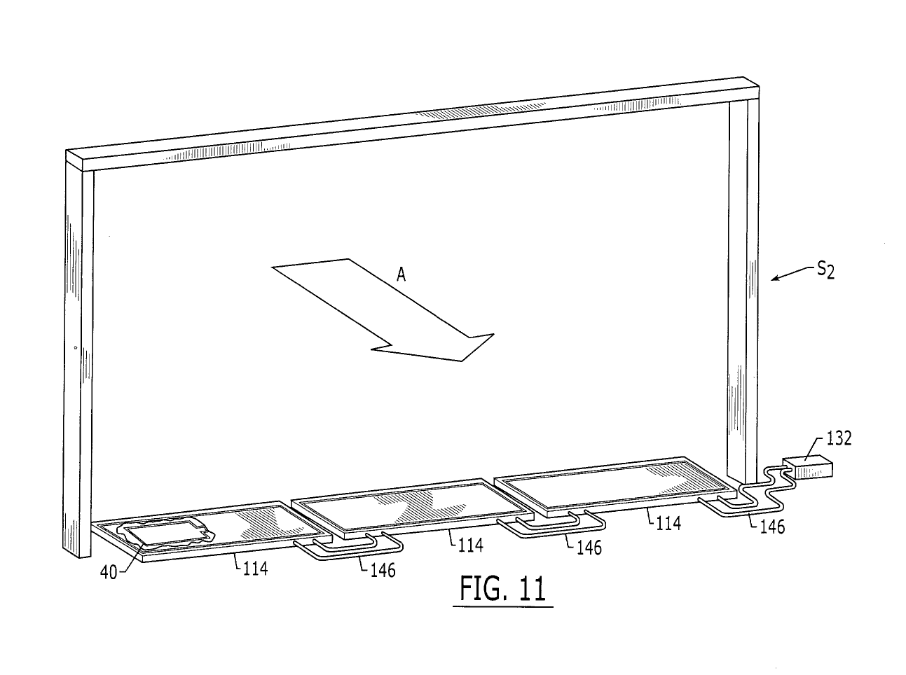

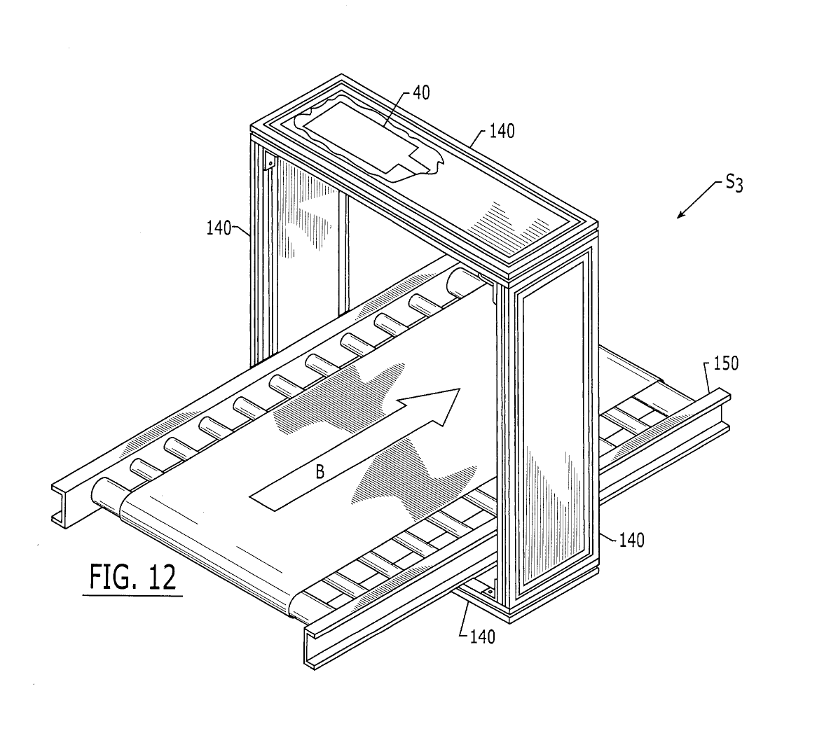

According to the invention, the RFID antennas of the invention can be employed as stand alone systems, having control means (e.g., computer) in communication with the antenna (e.g., 40, 90, 80) or, as illustrated in FIGS. 11 and 12, incorporated in modular RFID antenna systems disclosed in U.S. Pat. No. 6,445,297 and application Ser. No. 09/927,795, which are incorporated by reference herein.

Referring first to FIG. 11, there is shown a modular (or “pass-thru”) antenna system S₂ incorporating the RFID antenna 40 of the invention. As illustrated in FIG. 11, the antenna system S₂ preferably includes a plurality of low-profile antenna panels 114; each panel 114 having an antenna apparatus 40, as described herein. The antenna system S₂ further includes a controller 132 that is operatively connected to each antenna 40 and, hence, panel 114, which are inter-connected via cable system 146.

As illustrated in FIG. 11, the panels 114 can be employed proximate the floor or ground of a structure (or building). As described in detail in the '297 patent, the noted configuration and placement of the panels 114 facilitates communication by and between the panels 114 and one or more RFID tags (or tagged items) that pass over the panels 114.

Referring now to FIG. 12, there is shown a conveyor “pass-thru” antenna system S₃. As illustrated in FIG. 12, the antenna system S₃, which, according to the invention, similarly includes a plurality of antenna panels 140 having an antenna apparatus 40 of the invention, facilitates communication by and between the inter-connected antenna panels 140 and one or more tags that pass through the antenna field (or fields) via conveyor 150.

Applicant has found that the H-shape RFID antennas of the invention provide a substantially uniform tag read area or plane that is substantially devoid of “null points” or “holes”, which is a major advantage over conventional figure eight antenna configurations. The RFID antennas also provide: (i) enhanced vertical coverage without the need for multiple loop elements or rotating fields; (ii) enhanced “near field” read range; (iii) minimal coupling in the “far field”; and (iv) minimal field projection into the ground.

As discussed in the Examples section below, the H-shape RFID antennas of the invention further exhibit additional negative gain as compared to conventional figure eight antenna systems, which allows for a substantially higher power to be employed.

### EXAMPLES

The following examples that are set forth herein are for illustrative purposes only and are not meant to limit the scope of the invention in any way.

### Example 1

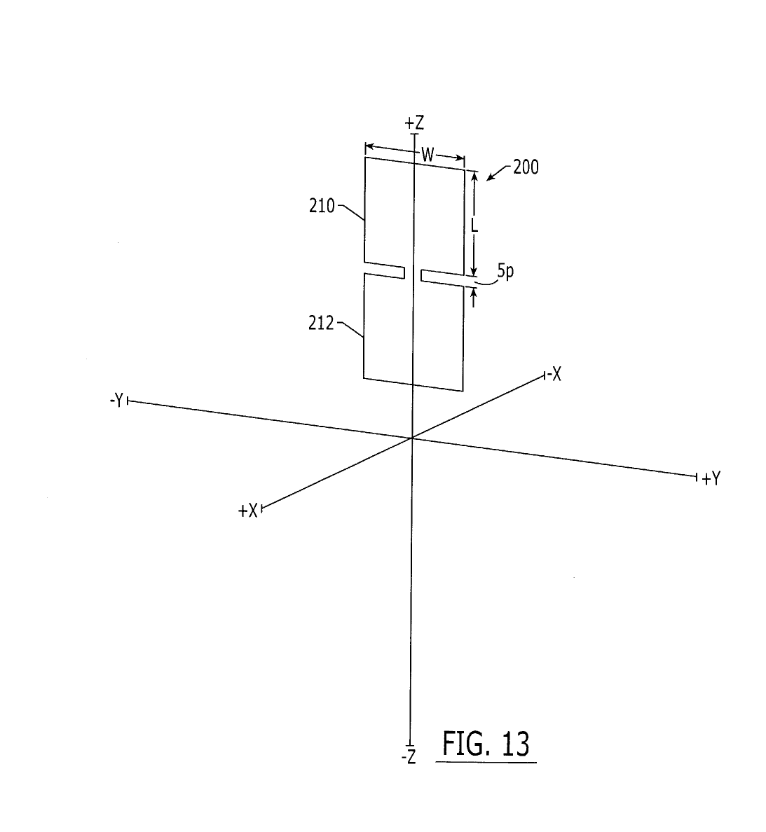

Referring to FIG. 13, a conventional figure eight (“FIG. 8”) antenna system (designated 200) having two substantially equal antenna loops 210, 212 was provided. Each antenna loop was approximately 24.0 in. in length (designated “I”) and 24.0 in. in width (designated “w”). The antenna loops were spaced 2.0 in. apart (designated “sp”) and tuned to approximately 13.56 MHz. The noted FIG. 8 antenna system 200 exhibited a maximum gain of approximately −24.23 dBd.

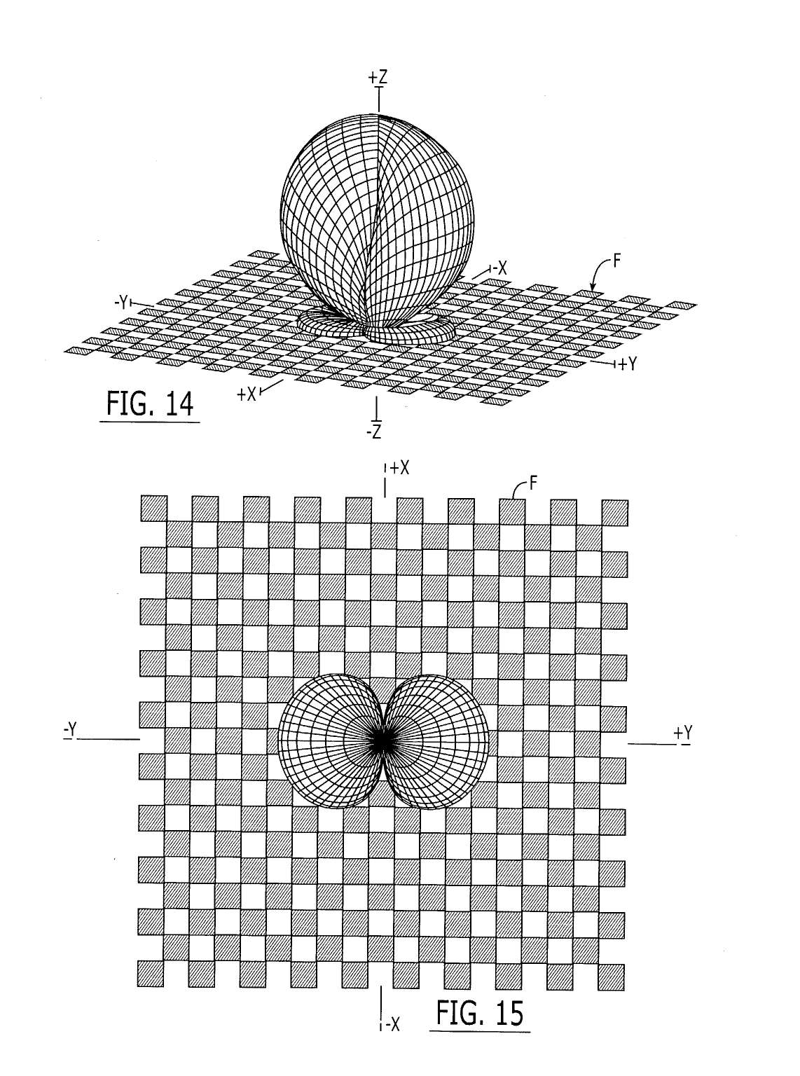

Referring now to FIGS. 14-17, there are shown the electric far field surface plots, illustrating the field characteristics of the FIG. 8 antenna system 200. The checked area, designated “F”, represents the ground or floor, which in FIG. 14 is substantially coincident with the X and Y axes.

Referring first to FIG. 14, it can be seen that the FIG. 8 antenna system 200 exhibits a null in the +X direction that is dissimilar to the null in the +Y, −Y axis. FIG. 15 further illustrates that when viewed from the Z axis (downward), the +Y and −Y axis lobes (maximas) completely obscure the −X and +X maximas and nulls.

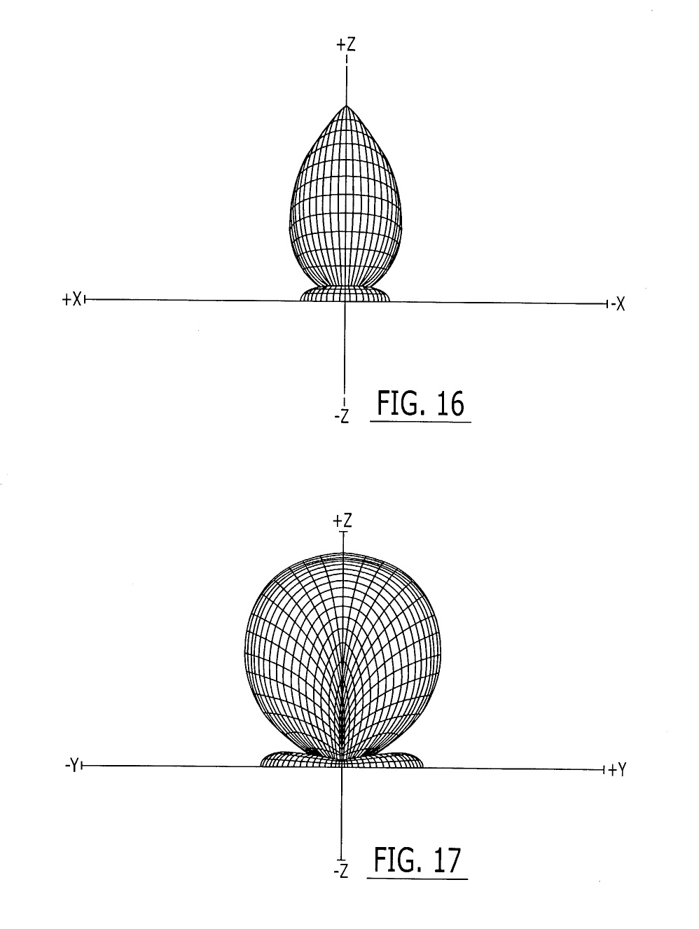

Similarly, FIGS. 16 illustrates that the null in the +X, −X axis is optimal in one elevation and angle. As illustrated in FIG. 17, the null also exists over a much wider area.

### Example 2

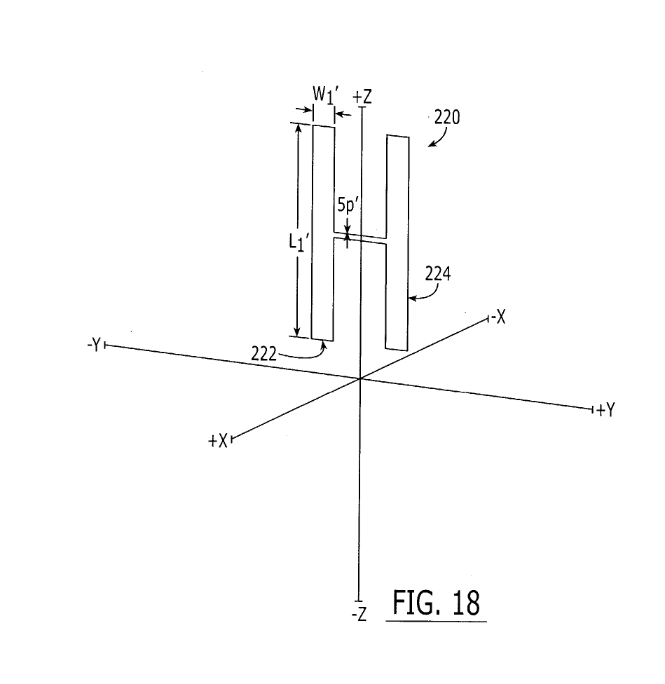

Referring to FIG. 18, a H-shape RFID antenna system (designated 220) of the invention was provided. As illustrated in FIG. 18 and in accordance with the invention, the antenna system 220 included two substantially equal antenna loops 222, 224. Each antenna loop was approximately 76.0 in. in length (designated “L₁′”) and 8.0 in. in width (“W₁′”), The antenna loops were spaced 20.0 in. apart (designated “sp′”) and tuned to approximately 13.56 MHz.

The H-shape antenna system 220 exhibited a maximum gain of approximately −23.93 dBd. This is similar to the gain exhibited by the conventional FIG. 8 antenna system, i.e., −24.23 dBd

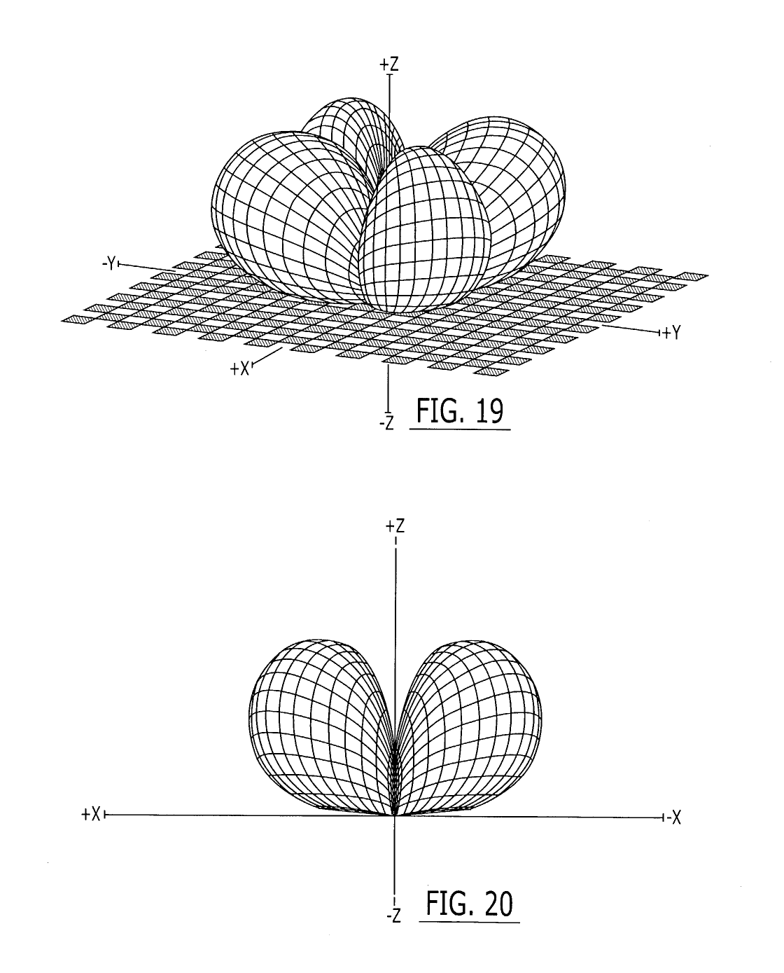

Referring now to FIGS. 19-22, there are shown electric far field surface plots for the H-shape antenna system 220. Referring first to FIG. 19, it can be seen that the H-shape antenna system 220 exhibits a four lobe, four null pattern.

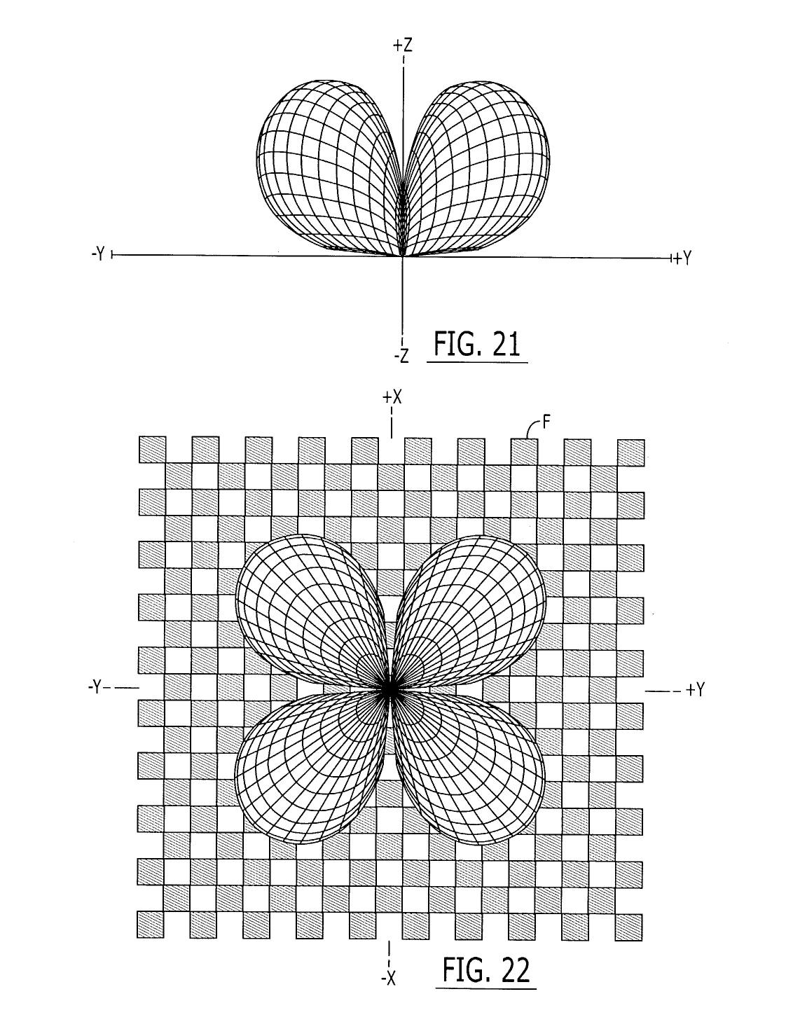

FIGS. 20 and 21 illustrate that the +X, −X lobes are equal in shape and magnitude. FIG. 22 further illustrates that the four nulls have equal depth.

### Example 3

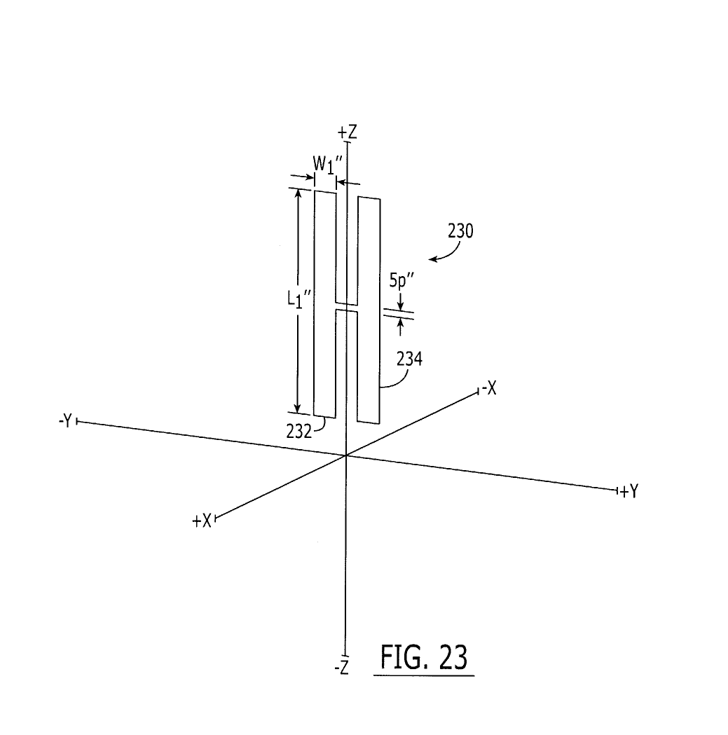

Referring to FIG. 23, a further embodiment of a H-shape RFID antenna system (designated 230) of the invention was provided. As illustrated in FIG. 23, the antenna system 230 similarly included two substantially equal antenna loops 232, 234. Each antenna loop was approximately 76.0 in. in length (designated “L₁″”) and 8.0 in. in width (“W₁″”). The antenna loops were spaced 8.0 in. apart (designated “sp″”) and tuned to approximately 13.56 MHz. The H-shape antenna system 230 exhibited a maximum gain of approximately −26.88 dBd.

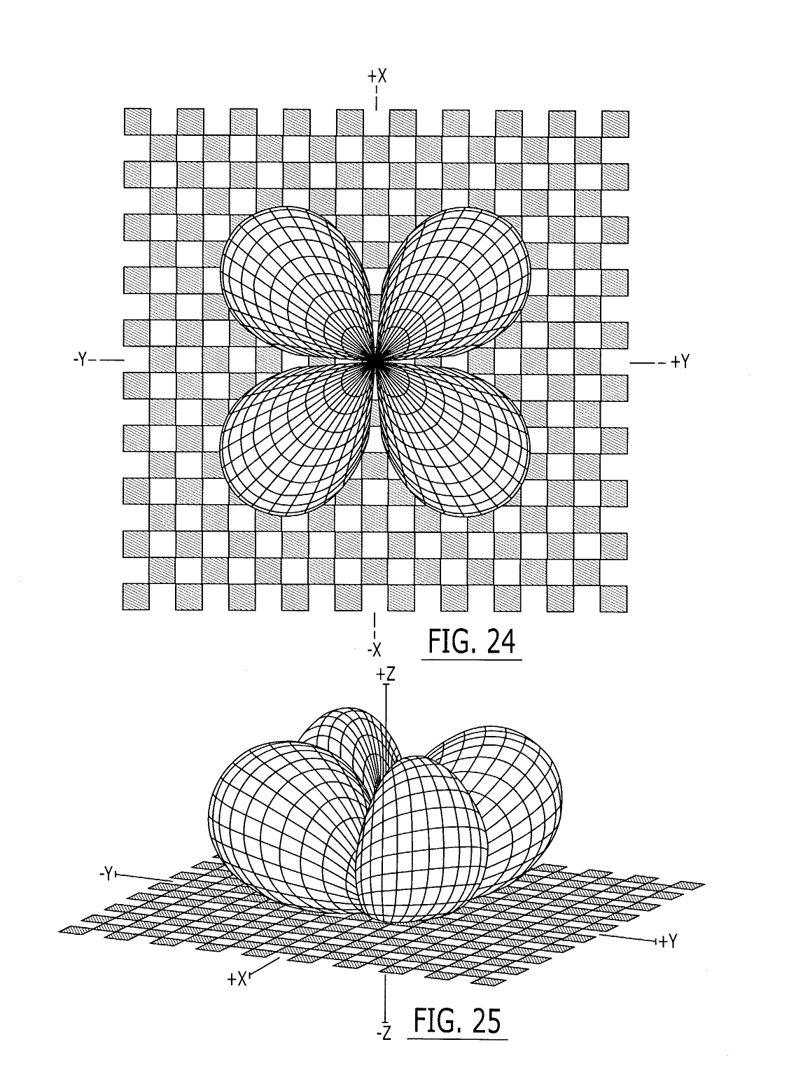

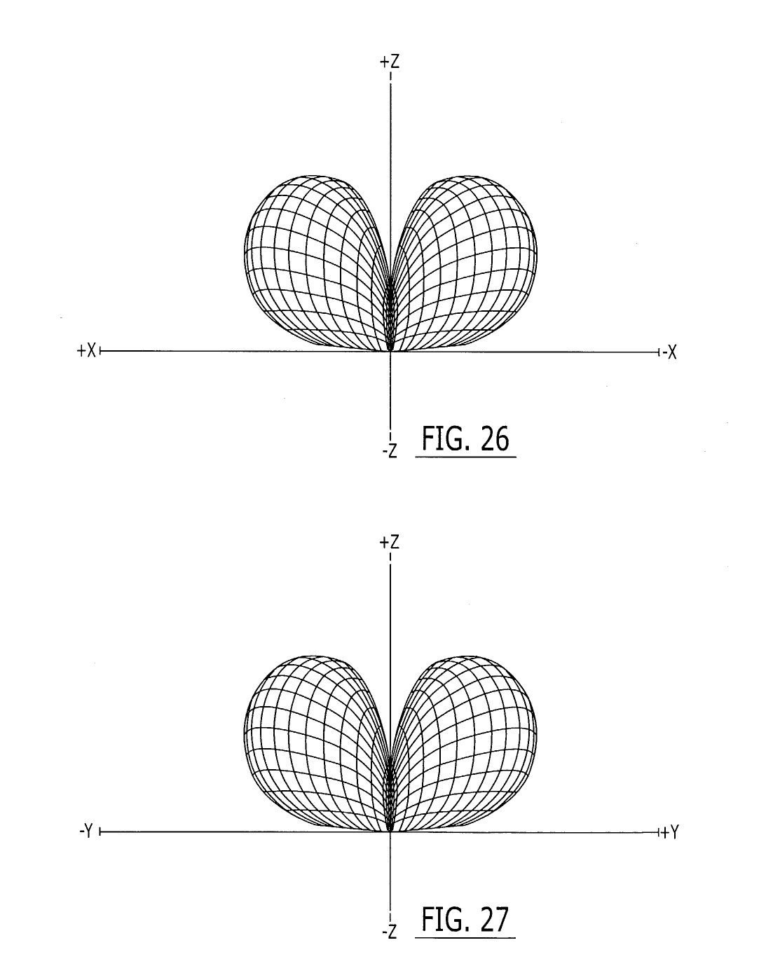

Referring now to FIGS. 24-27, there are shown the electric far field surface plots for the H-shape antenna system 230. As illustrated in FIGS. 24 and 25, the antenna system 230 similarly exhibits four equal lobes and four equal nulls. FIGS. 26 and 27 illustrate that the lobes are of equal shape and magnitude.

As will be appreciated by one having ordinary skill in the art, the noted performance of the H-shape RFID antenna systems of the invention significantly exceeds that of conventional FIG. 8-antenna systems. Indeed, as demonstrated in Example 3, in one embodiment, the H-shape RFID antenna system of the invention exhibited a 2.65 dB advantage in antenna gain. The noted additional negative gain allows for a substantially higher power to be used with the H-shape antenna systems of the invention as compared to conventional FIG. 8 antenna systems.

Examples 2 and 3 demonstrate that the H-shape RFID antenna systems of the invention exhibit a substantially symmetrical cancellation pattern, i.e., uniform patterns of lobes (maximas) and nulls (minimas) about the Z-axis. Examples 2 and 3 further demonstrate that further improvements in cancellation can be achieved by spacing the loops closer together.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. An antenna apparatus, comprising:
a substantially H-shaped antenna structure, said antenna structure having substantially coplanar first and second loop elements and a crossover element, said first and second loop elements having substantially similar geometric shapes of substantially equal dimension, said crossover element having a pair of spaced, substantially parallel conductors electrically connecting said first and second loop elements; and
a drive element for driving said antenna structure,
said antenna apparatus providing a substantially uniform tag read area that is substantially devoid of null points.

2. The antenna apparatus of claim 1, wherein each of said first and second loop elements has a nominal width in the range of approximately 4-5 in. and a nominal length in the range of 36-100 in.

3. The antenna apparatus of claim 2, wherein each of said first and second loop elements has a nominal width in the range of approximately 8-12 in. and a nominal length in the range of approximately 48-90 in.

4. The antenna apparatus of claim 1, wherein the space between said first and second loop elements is in the range of approximately 1-5 ft.

5. The antenna apparatus of claim 1, wherein said antenna apparatus is operable at radio frequencies less than approximately 50 MHz.

6. The antenna apparatus of claim 5, wherein said antenna apparatus has a frequency in the range of 13-14 MHz.

7. The antenna apparatus of claim 1, wherein said antenna apparatus is operable with an input power less than approximately 30 watts, while maintaining an ultraviolet intensity of approximately 10,000 UV/m.

8. The antenna apparatus of claim 1, wherein said antenna apparatus has an input power in the range of 10-20 watts.

9. A modular RFID antenna system, comprising:
a plurality of modular antenna segments, each of said plurality of antenna segments having an antenna adapted to transmit and receive at least one RF signal from at least one RF tag,
said antenna having a substantially H-shaped antenna structure, said antenna structure having substantially coplanar first and second loop elements and a crossover element, said first and second loop elements having substantially similar geometric shapes of substantially equal dimension, said crossover element having a pair of spaced, substantially parallel conductors electrically connecting said first and second loop elements and a drive element for driving said antenna structure,
said antenna segments being removably connectable to form a plurality of antenna system configurations, at least a first of said plurality of antenna system configurations providing a first antenna field, said first antenna field providing substantially multi-directional RF transmission and receipt of said RF signal.
